(19) United States
(12) Patent Application Publication
(10) Pub. No.: US 2004/0041520 A1
(43) Pub. Date: Mar. 4, 2004

(54) Panel for organic electroluminescent device

(75) Inventors: Ching-Huei Wu, Chung-Ii City (TW); Tien-Rong Lu, Tainan City (TW); Ching-Te Lin, Hsinchu (TW); Yih Chang, Jhonghe City (TW)

Correspondence Address: BACON & THOMAS, PLLC, 625 SLATERS LANE, FOURTH FLOOR, ALEXANDRIA, VA, 22314

(73) Assignee: RiTdisplay Corporation, Hsin Chu Industrial Park (TW)

(21) Appl. No.: 10/648,336

(22) Filed: Aug. 27, 2003

(30) Foreign Application Priority Data
Aug. 27, 2002 (TW) 91119461
Aug. 27, 2002 (TW) 91119460
Aug. 27, 2002 (TW) 91119459

(51) Int. Cl. H01J 1/62

(52) U.S. Cl. 313/506

(57) ABSTRACT

A panel for an organic electroluminescent device is disclosed, which has a substrate having a first conducting area, a second conducting area, a third conducting area, and an active area; wherein active area locates between first conducting area and second conducting area; third conducting area locates at one side of active area; first conducting area, second conducting area, third conducting area and active area are integrated together on the surface of substrate; and third conducting area locates adjacent to first conducting area, second conducting area, and active area; a plurality of first conducting lines located in first conducting area on the substrate, a plurality of second conducting lines located in second conducting area on the substrate, and a plurality of third conducting lines located in third conducting area on the substrates.

### BACKGROUND OF THE INVENTION

1. Field of the Invention

The present invention relates to a panel for a flat panel display device and, more particularly, to a panel for an organic electroluminescent device (OELD).

2. Description of Related Art

Currently, two major display devices (i.e. CRT display devices and flat panel display devices) are widely applied in the world. Because of the advantages of lightweight and compact, flat panel display devices such as liquid crystal display (LCD) devices or organic electroluminescent devices become more and more popular.

Organic electroluminescent devices become focus among flat panel display devices in recent years because they emit light spontaneously. In other words, the pixels on the organic electroluminescent device can display colored light without external backlight modules. Therefore, an organic electroluminescent device can be a suitable flat panel display device for future owing to the advantages of lightweight, mini-size, and thin-thickness. So far, the panel used for the conventional passive organic electroluminescent device is similar to that for the passive LCD panel. For example, the substrate having stripes of transparent electrodes used for the passive organic electroluminescent device is almost the same to that for the passive liquid crystal display devices. Generally, an active area having stripes of transparent electrode can be found on the substrate of a panel for conventional passive LCDs or passive organic electroluminescent devices. Outside the active area, several conducting lines are laid on the substrate of the panel. The stripes of the active area function as apart of pixels for displaying images. The conducting lines connect the stripes of electrode and bonded integrated circuits or external printed circuit board for providing power or signals.

In most cases, the conducting lines are disposed on the substrate in a distribution of “L”. In other words, conducting lines surround the active area two-dimensionally (i.e. in X-Y dimension or in X-Y distribution). However, since most conducting lines distributed heavily on the two adjacent sides of the active area, the width from the active area to the edge of the panel cannot be reduced effectively. On the other hand, since the distribution of the conducting lines based one the conventional passive organic electroluminescent device or LCD panel is not symmetrical, it is inconvenient to assemble the panel into a shell or a module. Of course, the design for the shell for locating the conventional passive OEL panel is also limited owing to the unsymmetrical arrangement of the conducting lines on the conventional passive OEL panels. Beside, many spaces of shells used for locating this panel are wasted since the distribution of the conducting lines disposed on the substrate un-symmetrically. In other words, the unsymmetrical distribution of the conducting lines also limits the designing work or the application of the shells or frames outside the panel. In addition, symmetrical arrangement is more popular among consumers. It is difficult to use the conventional passive OELD to design a symmetrical OELD without waste of spaces.

Moreover, as the number of the electrodes in the active area increases, the number of the conducting lines for transmitting signals needs to be increased, too. However, the conventional indium tin oxide (ITO) used in LCD is adopted as the conducting lines in small panels of OELDs. The conductivity of ITO is lower than that of metal cathode in OELDs. In particular, the conductivity of organic electroluminescent medium is significantly lower that of metal cathode or ITO. The conductivity issues shall cause the current density limitation leading to a low brightness and high power consumption of display if the conventional layout of ITO conducting lines in LCD is used in OELD. Therefore, the width from the active area to the edge of the substrate has to be increased to allow enough conducting lines to be laid on. These disadvantages illustrated above will become more and more serious as the resolution of the active area increases or as the number of the required conducting lines increase.

Therefore, it is desirable to provide an improved to mitigate the aforementioned problems.

### SUMMARY OF THE INVENTION

The object of the present invention is to provide a panel for an organic electroluminescent device having relatively symmetrical distribution of conducting lines to reduce the waste of spaces, to facilitate the assembling of organic electroluminescent panels and external shells, to increase the reliability of assembling, to increase the ease for reworking panels and brightness, and to lower down the cost for mass-production and power consumption.

To achieve the object, the panel for an organic electroluminescent device of the present invention includes: a substrate having a first conducting area, a second conducting area, a third conducting area, and an active area; wherein said active area locates between said first conducting area and said second conducting area; said third conducting area locates at one side of said active area; said first conducting area, said second conducting area, said third conducting area and said active area are integrated together on the surface of said substrate; and said third conducting area locates adjacent to said first conducting area, said second conducting area, and said active area; a plurality of first conducting lines located in said first conducting area on said substrate; a plurality of second conducting lines located in said second conducting area on said substrate; a plurality of third conducting lines located in said third conducting area on said substrate; a plurality of first electrodes located in said active area, wherein said first electrode connects a third conducting line; a plurality of second electrodes located in said active area, wherein said second electrode connects a first conducting line or a second conducting line; and at least one organic electroluminescent medium located in said active area, wherein said organic electroluminescent medium is sandwiched between said first electrode and said second electrode; wherein said first conducting lines connects a third conducting line, said second conducting line connects a third connecting line, said first electrodes don't directly connect said second electrodes, and said first conducting lines, said second conducting lines, said third conducting lines and said first electrodes are on the surface of said substrate.

Another panel for an organic electroluminescent device of the present invention, includes: a substrate having a first conducting area, a second conducting area, a third conducting area, a first film, and an active area; wherein said active area locates between said first conducting area and said second conducting area; said third conducting area locates at one side of said active area; said first conducting area, said second conducting area, said third conducting area and said active area are integrated together on the surface of said substrate; and said third conducting area locates adjacent to said first conducting area, said second conducting area, and said active area; a plurality of first conducting lines located in said first conducting area on said substrate; a plurality of second conducting lines located in said second conducting area on said substrate; a plurality of third conducting lines located in said third conducting area on said substrate, said first conducting line connects a third conducting line; said second conducting line connects a third connecting line; a plurality of first electrodes located in said active area, wherein said first electrode connects a third conducting line; a plurality of second electrodes located in said active area, wherein said second electrode connects a first conducting line or a second conducting line; at least one organic electroluminescent medium located in said active area, wherein said organic electroluminescent medium is sandwiched between said first electrode and said second electrode; and a first film embedded with a plurality of fourth conducting lines, wherein said fourth conducting lines are electrically connected with the third conducting lines, at least part of the pins of an integrated circuit, or a combination thereof.

The panel for an organic electroluminescent device of the present invention can optionally further comprises a bonding unit or a bonding area inside the third conducting area for bonding at least one integrated circuit or a cable. Preferably, pads can be set in the bonding area for bonding pins of integrated circuit chips or lines of cables. Optionally, part of the pins of the integrated circuit can be wire bonded to external lines for transmitting signals. The materials of the first conducting lines, the second conducting lines or the third conducting lines can be any conventional conductive materials. Preferably, the first conducting lines, the second conducting lines, or the third conducting lines are selected from aluminum (Al), chromium (Cr), silver (Ag), and alloys thereof. The panel for an organic electroluminescent device of the present invention can optionally further comprises a plurality of auxiliary electrodes located on the surface of or embedded in said first electrodes. The auxiliary electrodes are used to increase the current density of the first electrodes. The auxiliary electrodes can be made of any conventional metal or conductive alloy. Preferably, the auxiliary electrodes are made of the same materials as those of the first conducting lines, the second conducting lines, or the third conducting lines. More preferably, the auxiliary electrodes, the first conducting lines, the second conducting lines, and the third conducting lines are made of the same materials for simplifying the manufacturing process and for saving cost of materials. The organic electroluminescent medium can be any conventional organic materials (e.g. small-molecular type or polymer type) for electroluminescence purpose. Furthermore, the organic electroluminescent medium optionally can be conventional multi-layers having electron injecting layer, electron transporting layer, organic electroluminescent layer, hole transporting layer, and hole injecting layer.

The number of the first conducting lines is not limited. Preferably, the number of the conducting lines is the identical to that of the second conducting lines. Said first conducting lines or said second conducting lines are integrated with the third conducting lines. The panel for an organic electroluminescent device of the present invention can optionally includes at least one pixel-defining layer located between said organic electroluminescent medium to define the pixel area of said first electrodes in said active area. The pixel-defining layer located on part of the surface of the substrate or part of the surface of the first electrodes. Preferably, there are windows on the pixel-defining layer for exposing the organic electroluminescent medium of pixels. The edge of the windows of the pixel-defining layer can clearly define the area of the pixels of an active area of the organic electroluminescent panel. The materials of the pixel-defining layer are not limited. Preferably, the pixel-defining layer is made of polyimide. The first electrodes can be made of any conventional transparent conductive materials (e.g. metals or transparent conductive materials). Preferably, the first electrodes are made of ITO. The second electrodes can be made of any conventional conductive materials. Preferably, the second electrodes are made of ITO, aluminum, alloys of silver and magnesium. The panel for an organic electroluminescent device can optionally include a plurality of isolating walls. The isolating walls locate on the surface of said pixel-defining layer. The isolating walls can be made of any isolating materials. Preferably, the isolating walls are made of photoresist or polyimide. The first electrodes, the organic electroluminescent medium, the second electrodes, the first conducting lines, the second conducting lines, the third conducting lines, and the pixel-defining layer can be formed through conventional fabrication method. Preferably, they are formed through necessary vapor deposition and photolithography.

The arrangement of the first conducting lines is not limited. Preferably, the first conducting lines are parallel to each other. The arrangement of the second conducting lines is not limited. Preferably, the second conducting lines are parallel to each other. The arrangement of the first electrodes is not limited. Preferably, the first electrodes are parallel to each other. The arrangement of the second electrodes is not limited. Preferably, the second electrodes are parallel to each other. The arrangement of the isolating walls is not limited. Preferably, the isolating walls are parallel to each other. The project of the first electrodes on the substrate intersects with the project of the second electrodes on the substrate. Preferably, the project of the first electrodes on the substrate intersects with the project of the second electrodes on the substrate perpendicularly. The active area can be further sealed with a barrier cover for preventing moisture, or any sensitive chemical pollutants (e.g. oxygen, oxide, or sulfide in the air). The integrated circuits are optionally bonded on the bonding unit in the third conducting area. Preferably, the integrated circuits are bonded on the substrate through COG (chip on glass) bonding.

The panel of the present invention with a first film can optionally includes an integrated circuit, a printed circuit board and a second films, wherein part of said pins of said integrated circuit connects with said second film, and said printed circuit board electrically connects said second films. Or the panel of the present invention with a first film can optionally includes a printed circuit board and a second film, wherein part of said pins extends from said integrated circuit and is embedded in said second film, and said extended pins embedded in said second film connect to said printed circuit board. The integrated circuit and the printed circuit board can be bonded with conventional methods. Preferably, the integrated circuit and the printed circuit board are connected through anisotropic conductive films or wire bonding. The first film can optionally includes a plurality of fifth conducting lines embedded in said first film, wherein said fourth conducting lines and said fifth conducting lines do not connect to each other directly, part of pins of said integrated circuit electrically connects to said fourth conducting lines, and the other part of pins of said integrated circuit electrically connects to said fifth conducting lines. The first film can be optionally bonded with plural electrically passive devices through the fourth conducting lines. Preferably, the electrically passive devices are capacitors or resistors.

Other objects, advantages, and novel features of the invention will become more apparent from the following detailed description when taken in conjunction with the accompanying drawings.

### BRIEF DESCRIPTION OF THE DRAWINGS

FIG. 1 is a top view of the panel of the OELD of the first embodiment of the present invention;

FIG. 2 is a top view of the panel of the OELD of the second embodiment of the present invention;

FIG. 3 is a perspective view of the panel of the OELD of the first embodiment of the present invention without showing the organic electroluminescent layer, isolating walls, and the second electrodes;

FIG. 4 is a cross section view of part of the panel of the OELD of the first embodiment of the present invention;

FIG. 5 is a perspective view of the panel of the OELD of the first embodiment of the present invention without showing the organic electroluminescent layer, isolating walls, and the second electrodes;

FIG. 6 is a perspective view of the panel of the OELD of the first embodiment of the present invention;

FIG. 7 is a perspective view of the panel of the OELD of the second embodiment of the present invention;

FIG. 8 is a perspective view of the panel of the OELD of the third embodiment of the present invention;

FIG. 9 is a perspective view of the panel of the OELD of the forth embodiment of the present invention; and

FIG. 10 is a perspective view of the panel of the OELD of the fifth embodiment of the present invention.

### DETAILED DESCRIPTION OF THE PREFERRED EMBODIMENT

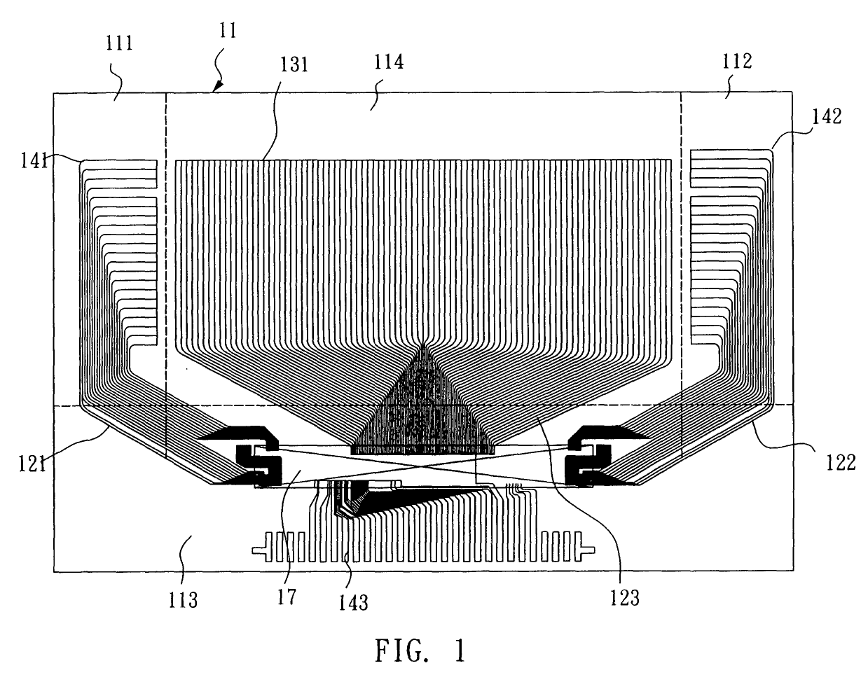

With reference to FIG. 1, there is shown a first embodiment of the organic electroluminescent panel of the present invention. The distribution of the conducting lines and the active area on an organic electroluminescent panel of the present invention can be found in FIG. 1. The organic electroluminescent panel of the present invention includes a substrate 11. The surface of the substrate 11 is divided into several areas such as a first conducting area 111, a second conducting area 112, a third conducting area 113 and an active area 114. The active area 114 locates between the first conducting area 111 and the second conducting area 112. The third conducting area 113 is adjacent to the active area 114, the first conducting area 111 and the second conducting area 112. The substrate of the organic electroluminescent panel of the present invention can be any transparent or semi-transparent materials. In this embodiment, the substrate 11 is made of glass.

As shown in FIG. 1, there are first conducting lines 141 in the first conducting area 111 on the substrate 11. The first conducting lines 141 further extend to connect the third conducting lines 121 in third conducting area 113. As shown in FIG. 1, none of the first conducting lines 141 electrically connect to each other. Preferably, the first conducting lines 141 are parallel to each other. For decreasing the width between the edge of the substrate and the active area 114, the first conducting lines 141 are formed in a shape of “L”. Similarly, there are second conducting lines 142 in the second conducting area 112 on the substrate 11. The second conducting lines 142 further extend to connect the third conducting lines 122 in the third conducting area 113 or to connect other electrical parts (e.g. pins of integrated circuits). Likewise, for decreasing the width between the edge of the substrate and the active area 114, the second conducting lines 142 are formed in a shape of “L”. The first conducting lines 141 are used to connect part of the second electrodes 132 in the active area 114 and the parts bonded in the third conductive area 113. The second conducting lines 142 are used to connect part of the second electrodes 132 in the active area 114 and the parts bonded in the third conducting area 113. The third conducting lines 121, 122, 123 are used to respectively connect the first conducting lines 141, the second conducting lines 142, the first electrodes 131 in the active area 114, and optionally the parts (e.g. pins of integrated circuits) bonded in the third conductive area 113. Moreover, the integrated circuit can optionally connect to other external cables or external lines through extra conducting lines 143 which is not connected with the third conducting lines directly. The number of the first conducting lines 141 or the number of the second conducting lines 142 is not limited. In this embodiment, the number of the first conducting lines 141 is equal to that of the second conducting lines 142.

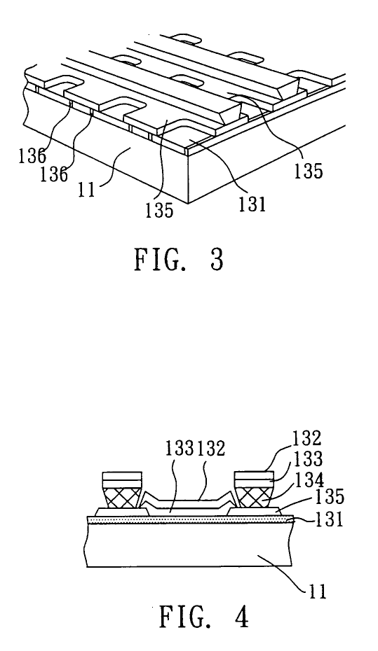

The active area 114 has a plural of first electrodes 131, second electrodes 132, organic electroluminescent medium 133, and pixel-defining layer 135 (shown in FIG. 3). In this embodiment, the first electrodes 131 and the second electrodes 132 are parallel stripes. The organic electroluminescent medium 133 is sandwiched between the first electrode 131 and the second electrode 132. The project of the second electrodes on the substrate intersects the first electrodes perpendicularly. However, the first electrodes don't electrically connect the second electrodes directly. In addition, the pixels locate on the intersection of the first electrodes and the second electrodes. The area of the single pixel is the intersection area of the first electrodes and the second electrodes.

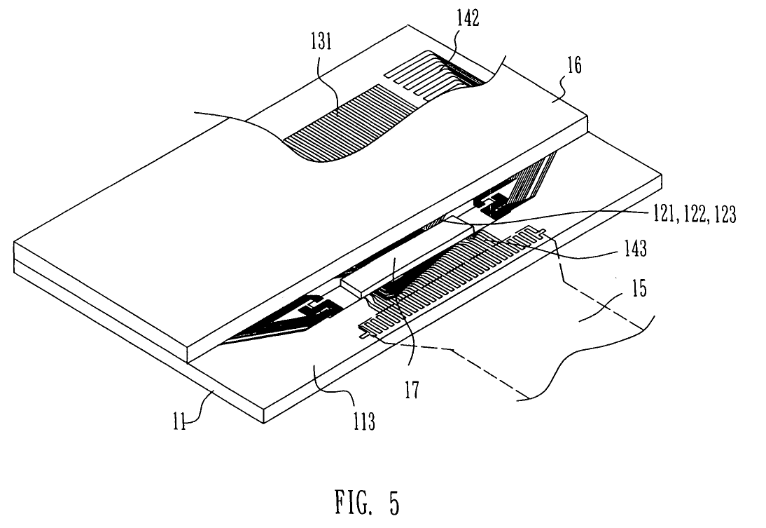

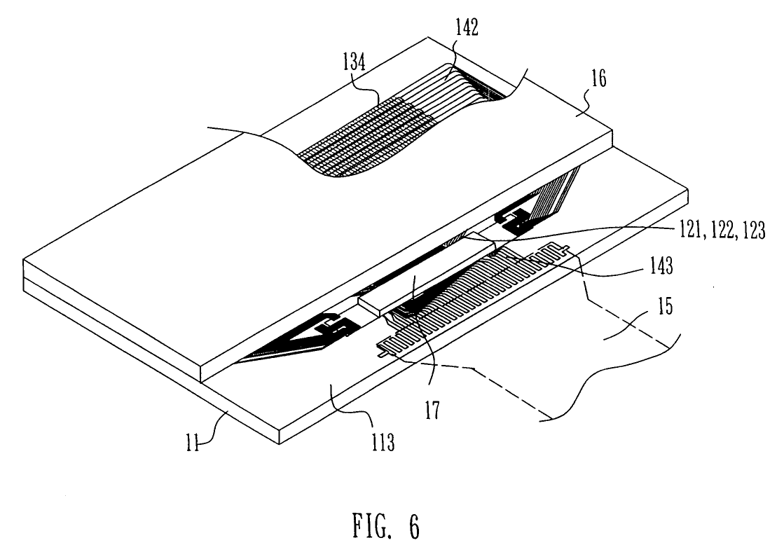

Part of the detailed structure of the active area can be seen in FIG. 3 or FIG. 4. As shown in FIG. 3 and FIG. 4, there are several windows on the pixel-defining layer 135 for exposing the organic electroluminescent layer 133 and define the border of the pixel clearly. Several isolating walls 134 are formed between the second electrode s 132 on the substrate 11. In this embodiment, the isolating walls 134 are parallel ramparts protruding form the surface of the pixel-defining layer 135 on the substrate. The organic electroluminescent panel of the present invention can optionally include a barrier cover 16 for preventing the moisture or the chemical molecules from the sensitive organic electroluminescent medium in the active area. As shown in FIG. 5 and 6, the barrier cover 16 covers the active area 114, the first conducting area 111, and the second conducting area 112 through peripheral sealing in this embodiment.

In the active area 114, a plural of auxiliary electrodes 136 are embedded in the first electrodes 131 to increase the conductivity or the current density of the first electrodes 131 as the first electrodes are charged. In this embodiment, said first electrode is embedded with at least two auxiliary electrodes 136 for improving the current density on the first electrodes 131 (see FIG. 3). The materials of the auxiliary electrodes can be any conductive metals or alloys. In this embodiment, the auxiliary electrodes are selectedfrom aluminum, chromium, silver, and alloys thereof.

The organic electroluminescent device panel of the present invention can assembled to be an organic electroluminescent module when adequate integrated circuits or cable are bonded. The integrated circuits can be bonded to substrate by any conventional method. Preferably, the integrated circuits can be bonded to substrate through anisotropic conductive film (ACF), wire bonding or COG (chip on glass). The embodiment for this bonding is shown in FIG. 5 and FIG. 6. For being easy to illustrate and to show the distribution of the first electrodes 131, the second electrodes are not shown in FIG. 5. The barrier cover 16 is sealed on the active area 114 for protection. The complete organic electroluminescent module is shown in FIG. 6. The second electrodes 132 connect to the first conducting lines 141 and the second conducting lines 142 are shown in FIG. 6.

An integrated circuit 17 for controlling the displaying of the organic electroluminescent panel is bonded to the substrate through COG (chip on glass). A cable 15 is also bonded to the substrate for signal transmission. The pins of the integrated circuit 17 connect the cable 15 through the assistance of external conducting lines 143.

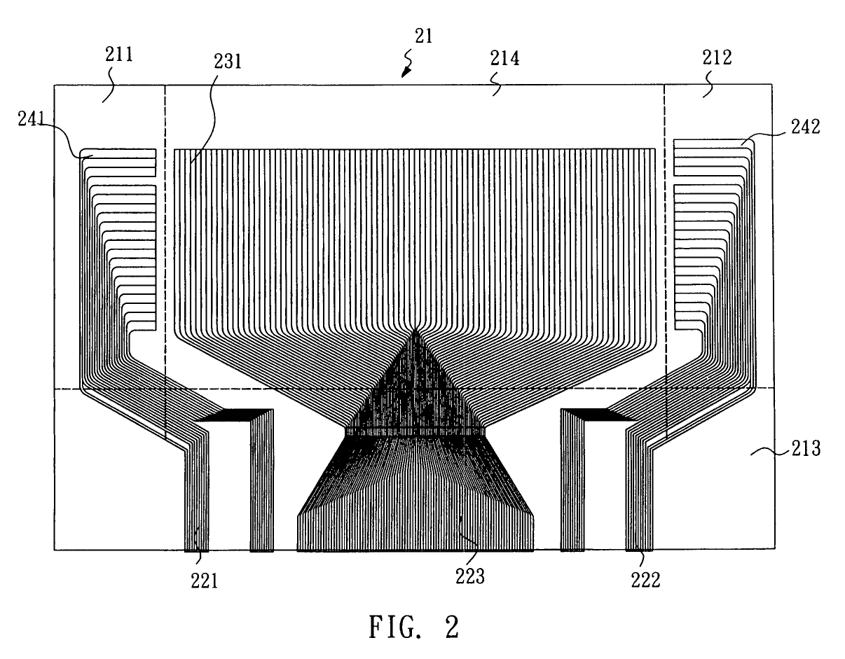

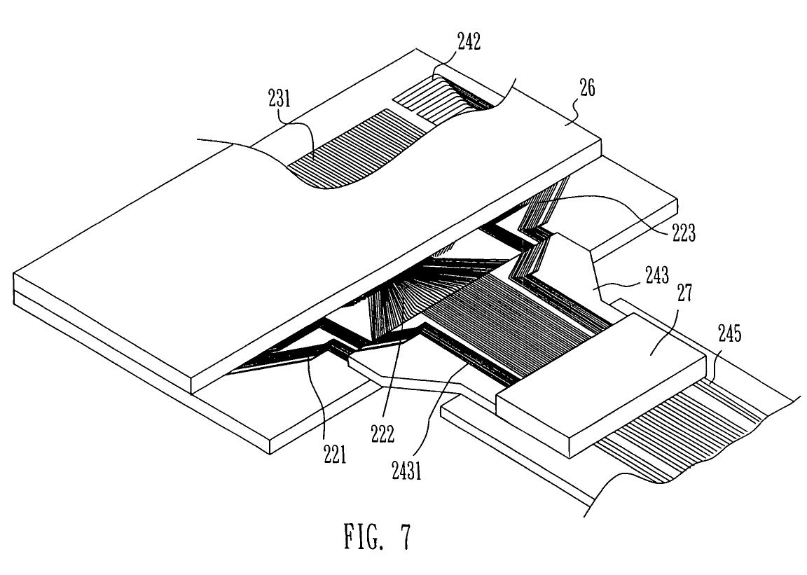

With reference to FIG. 7, there is shown a second embodiment of the organic electroluminescent panel of the present invention. The distribution of the conducting lines and the active area on an organic electroluminescent panel of the present embodiment (as shown in FIG. 2) is as same as that of the organic electroluminescent panel of the first embodiment. The arrangement of the first conducting lines 241, the second conducting lines 242, and the third conducting lines 221, 222, 223 are as same as that in of the organic electroluminescent panel of the first embodiment, too. However, the film 243 (see FIG. 7) bonded to the organic electroluminescent panel of the present embodiment is different from the integrated circuit bonded to the organic electroluminescent panel of first embodiment. The film 243 bonded to the third conducting lines 221, 222, 223 of the organic electroluminescent panel has plural fourth conducting lines 2431 embedded in the films 243. At least one integrated circuit 27 is connected to the fourth conducting lines 2431. In the present embodiment, one integrated circuit 27 is bonded to the fourth conducting lines 2431 of the film 243. Some pins of the integrated circuit 27 further bonds with a printed circuit board 245. The pins of the integrated circuit 27 can bonded with the printed circuit board 245 through any conventional bonding. In the present embodiment, the pins of the integrated circuit 27 bonds with the printed circuit board 245 through wire bonding. The metal for wire bonding used in the present invention can be any conventional metals or alloys for wire bonding. In the present embodiment, the metal used is aluminum or silver alloy. The signals can be transmitted from the printed circuit board 245 to the active area 214 of the organic electroluminescent panel through the assistance of the integrated circuit 27 and the fourth conducting lines 2431 of the film 243. In the present embodiment, the integrated circuit 27 is bonded to the panel through COB (chip on board). Through the connection of the film 27 and the printed circuit board 245, more integrated circuits for video or audio controlling signals can be attached on the organic electroluminescent panel for wide applications.

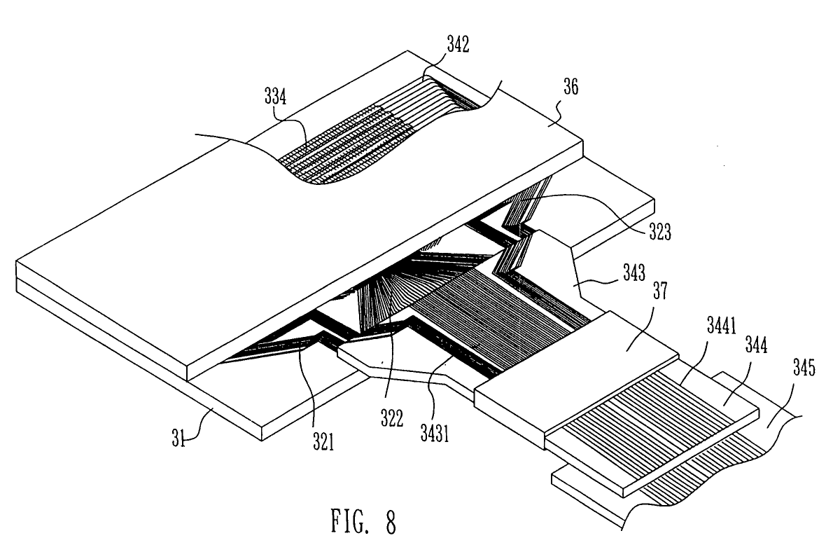

With reference to FIG. 8, there is shown a third embodiment of the organic electroluminescent panel of the present invention. The organic electroluminescent panel of the present embodiment is as same as that of the organic electroluminescent panel of the second embodiment except that the connection of the integrated circuit 37 with the printed circuit board 345. The fifth conducting lines 3441 of the film 344 are embedded in the film 344 and integrated with the pins of the integrated circuit 37. Then the fifth conducting lines 3441 of the films 344 are bonded to the print circuit board 345. Through the connection of the film 343, 344 and the printed circuit board 345 of the present embodiment, at least one integrated circuit for video or audio controlling signals can be attached on the organic electroluminescent panel for wide applications.

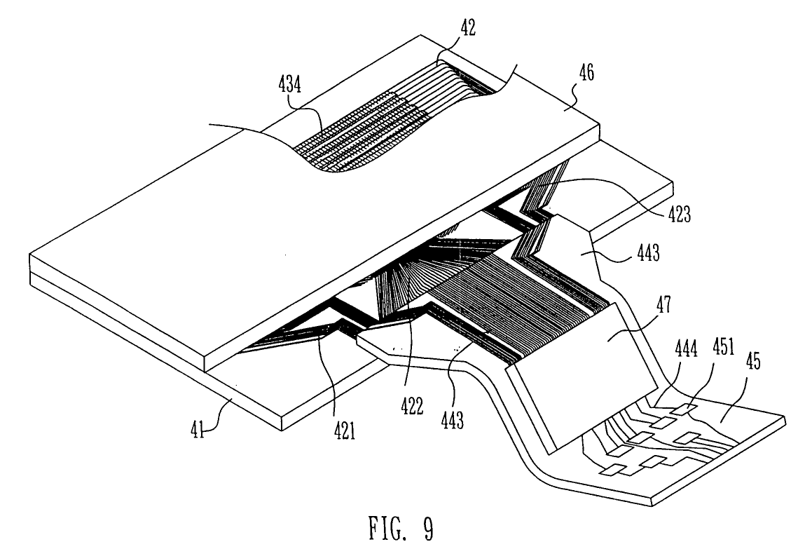

With reference to FIG. 9, there is shown a fourth embodiment of the organic electroluminescent panel of the present invention. The organic electroluminescent panel of the present embodiment is as same as that of the organic electroluminescent panel of the second embodiment except that the film 443 bonded with the panel and the integrated circuit 47. The film 443 in the present embodiment is a soft film can be folded or bent. The integrated circuit 47 is bonded on the central part of the soft film embedded with plural fourth conducting lines 4431. Some electrically passive devices 451 such as capacitors or resistors can be optionally bonded to the film 443. The connection of the present invention can increase the flexibility of the arrangement of the position of the integrated circuits and other parts.

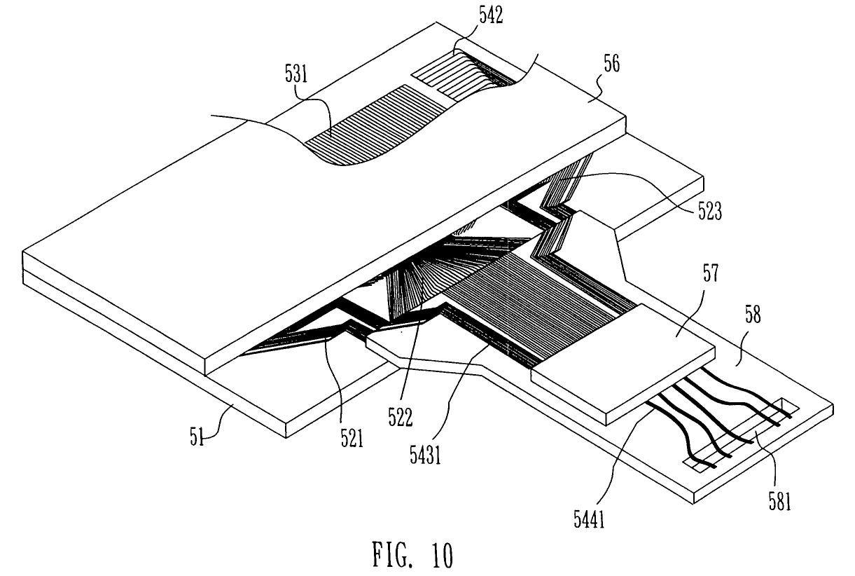

With reference to FIG. 10, there is shown a fifth embodiment of the organic electroluminescent panel of the present invention. The organic electroluminescent panel of the present embodiment is as same as that of the organic electroluminescent panel of the fourth embodiment except that the film 58 bonded with the panel and the integrated circuit 57. The film 58 used in the present embodiment is a hard film for tape carrier package (TCP). The hard film 58 is embedded with plural fourth conducting lines 5431, and optionally plural fifth conducting lines 5441. Holes 581 can be optionally made on the hard film 58 for heat dissipation purposes for wire bonding, too.

The arrangement of the conducting lines (e.g. the first conducting lines, the second conducting lines, and the third conducting lines) on the organic electroluminescent panel of the present invention can increase the flexibility of the application of space, and reduce the waste of the spaces and the un-symmetry of the arrangement of the conducting lines in the conventional organic electroluminescent panels. Moreover, owing to the symmetrical arrangement of the conducting lines on the substrate, the width between the active area and the edge of the panel can be effectively reduced. Therefore, the limit for designing the shell of the organic electroluminescent modules can be lifted out. Besides, the organic electroluminescent panel of the present invention can facilitate the assembling of the organic electroluminescent modules, too. In addition, since the space can be fully used, cost for special machines used for unsymmetrical panels and waste materials can be decreased.

Although the present invention has been explained in relation to its preferred embodiment, it is to be understood that many other possible modifications and variations can be made without departing from the spirit and scope of the invention as hereinafter claimed.

What is claimed is:

1. A panel for an organic electroluminescent device, comprising:
a substrate having a first conducting area, a second conducting area, a third conducting area, and an active area; wherein said active area locates between said first conducting area and said second conducting area; said third conducting area locates at one side of said active area; said first conducting area, said second conducting area, said third conducting area and said active area are integrated together on the surface of said substrate; and said third conducting area locates adjacent to said first conducting area, said second conducting area, and said active area;
a plurality of first conducting lines located in said first conducting area on said substrate;
a plurality of second conducting lines located in said second conducting area on said substrate;
a plurality of third conducting lines located in said third conducting area on said substrate;
a plurality of first electrodes located in said active area, wherein said first electrode connects a third conducting line;
a plurality of second electrodes located in said active area, wherein said second electrode connects a first conducting line or a second conducting line; and
at least one organic electroluminescent medium located in said active area, wherein said organic electroluminescent medium is sandwiched between said first electrode and said second electrode;
wherein said first conducting line connects a third conducting line, said second conducting line connects a third connecting line, said first electrodesdon't directly connect said second electrodes, and said first conducting lines, said second conducting lines, said third conducting lines and said first electrodes are on the surface of said substrate.

2. The panel as claimed in claim 1, further comprising a bonding unit located in said third conducting area for bonding at least one integrated circuit or a cable.

3. The panel as claimed in claim 1, wherein said integrated circuit or said cable is bonded to said bonding unit through chip on glass (COG) sealing.

4. The panel as claimed in claim 1, wherein the number of said first conducting lines is equal to that of said second conducting lines.

5. The panel as claimed in claim 1, wherein said conducting lines are selected from Al, Cr, Ag, and alloys thereof.

6. The panel as claimed in claim 1, further comprising at least a pixel-defining layer located between said organic electroluminescent medium to define the pixel area of said first electrode in said active area.

7. The panel as claimed in claim 1, further comprising a plurality of auxiliary electrodes located on the surface of or embedded in said first electrodes, and said auxiliary electrodes are used to increase the current density of the first electrodes.

8. The panel as claimed in claim 6, further comprising a plurality of isolating walls located on the surface of said pixel-defining layer.

9. The panel as claimed in claim 1, further comprising a barrier cover located above said active area for preventing said organic electroluminescent medium from the moisture, oxygen, oxide, or sulfide in the air, and said cover is bonded with said panel through sealing.

10. A panel for an organic electroluminescent device, comprising:
a substrate having a first conducting area, a second conducting area, a third conducting area, a first film, and an active area; wherein said active area locates between said first conducting area and said second conducting area; said third conducting area locates at one side of said active area; said first conducting area, said second conducting area, said third conducting area and said active area are integrated together on the surface of said substrate; and said third conducting area located adjacent to said first conducting area, said second conducting area, and said active area;
a plurality of first conducting lines locates in said first conducting area on said substrate;
a plurality of second conducting lines locates in said second conducting area on said substrate;
a plurality of third conducting lines locates in said third conducting area on said substrate, said first conducting line connects a third conducting line; said second conducting line connects a third connecting line;
a plurality of first electrodes located in said active area, wherein said first electrode connects a third conducting line;
a plurality of second electrodes located in said active area, wherein said second electrode connects a first conducting line or a second conducting line;
at least one organic electroluminescent medium located in said active area, wherein said organic electroluminescent medium is sandwiched between said first electrode and said second electrode; and
a first film embedded with a plurality of fourth conducting lines, wherein said fourth conducting lines are electrically connected with said third conducting lines, at least part of the pins of an integrated circuit, or a combination thereof.

11. The panel as claimed in claim 10, further comprising a printed circuit board, and said pins of said integrated circuit connect with said printed circuit board.

12. The panel as claimed in claim 11, wherein said pins of said integrated circuit and said printed circuit board are connected through anisotropic conductive films.

13. The panel as claimed in claim 10, further comprising a printed circuit board and a second films, wherein part of said pins of said integrated circuit connects with said second film, said printed circuit board electrically connects said second films.

14. The panel as claimed in claim 10, further comprising a printed circuit board and a second films, wherein part of said pins extends from said integrated circuit and is embedded in said second film, and said extended pins embedded in said second film connect to said printed circuit board.

15. The panel as claimed in claim 11, wherein said integrated circuit and said printed circuit board are connected through anisotropic conductive films or wire bonding.

16. The panel as claimed in claim 10, wherein the number of said first conducting lines is equal to that of said second conducting lines.

17. The panel as claimed in claim 10, wherein said conducting lines are selected from Al, Cr, Ag, and alloys thereof.

18. The panel as claimed in claim 10, further comprising at least one pixel-defining layer located between said organic electroluminescent medium to define the pixel area of said first electrode in said active area.

19. The panel as claimed in claim 10, further comprising a plurality of auxiliary electrodes located on the surface of or embedded in said first electrodes, and said auxiliary electrodes are used to increase the current density of the first electrodes.

20. The panel as claimed in claim 18, further comprising a plurality of isolating walls located on the surface of said pixel-defining layer.

21. The panel as claimed in claim 10, further comprising a barrier cover located above said active area for preventing said organic electroluminescent medium from the moisture, oxygen, oxide, or sulfide in the air, and said cover is bonded with said panel through sealing.

22. The panel as claimed in claim 10, further comprising a plurality of fifth conducive lines embedded in said first film, wherein said fourth conducting lines and said fifth conducting lines do not connect to each other directly, part of pins of said integrated circuit electrically connects to said fourth conducting lines, and the other part of pins of said integrated circuit electrically connects to said fifth conducting lines.

23. The panel as claimed in claim 10, wherein said first film is a hard film for tape carrier package (TCP).

24. The panel as claimed in claim 10, further comprising plural electrically passive devices bonded on said fourth conducting lines on said first film.

25. The panel as claimed in claim 24, wherein said electrically passive devices are capacitors or resistors.
